(19) United States
(12) Patent Application Publication
(10) Pub. No.: US 2020/0410073 A1
(43) Pub. Date: Dec. 31, 2020

(54) AUTHENTICATION CONTROL DEVICE AND AUTHENTICATION CONTROL SYSTEM

(71) Applicant: KABUSHIKI KAISHA TOKAI RIKA DENKI SEISAKUSHO, Aichi (JP)

(72) Inventor: Yosuke OHASHI, Aichi (JP)

(21) Appl. No.: 16/962,137

(22) PCT Filed: Dec. 27, 2018
(86) PCT No.: PCT/JP2018/048375

§ 371 Date: Jul. 14, 2020

(30) Foreign Application Priority Data
Jan. 19, 2018 (JP) 2018-007124

(51) Int. Cl. G06F 21/32; G06F 21/35; B60R 25/25; B60R 25/10; B60R 25/24

(52) U.S. Cl. CPC G06F 21/32; G06F 21/35; B60R 25/255; B60R 25/10; B60R 25/24; B60R 25/252

(57) ABSTRACT

An authentication control device includes a control unit that notifies to change related information when, after a first authentication by a first authentication device is successful and the priority level of the related information associated with the authenticated user is subsequently raised, the number of unsuccessful attempts of a second authentication performed by a second authentication device based on the related information reaches or exceeds a predetermined number.

### CROSS-REFERENCES TO RELATED APPLICATIONS

The present patent application claims the priority of Japanese patent application No, 2018/007124 filed on Jan. 19, 2018, and the entire contents of Japanese patent application No. 2018/007124 are hereby incorporated by reference.

### TECHNICAL FIELD

The present invention relates to an authentication control device and an authentication control system.

### BACKGROUND ART

A vehicle anti-theft device is known which is provided with a mobile device authentication means which authenticates a mobile device based on identification information received from the mobile device, a driver authentication means which acquires driver identification information unique to a driver and authenticates the driver as a pre-registered driver based on comparison with pre-registered driver identification information, an information input means receiving an input of setting information which is information set by the registered driver, and an authentication control means which selects either authentication using the driver authentication means or authentication based on the setting information input by the registered driver and controls start of a vehicle based on an authentication result from the selected authentication and an authentication result provided by the mobile device authentication means (see, e.g., Patent Literature 1).

This vehicle anti-theft device uses biometric information of the driver as the driver identification information. Then, in the biometric authentication mode to perform authentication by the driver authentication means, the vehicle anti-theft device controls start of the vehicle based on biometric authentication and an authentication result of the identification information.

### CITATION LIST

### Patent Literature

Patent Literature 1: JP 2010/208554 A

### SUMMARY OF INVENTION

### Technical Problem

When the vehicle anti-theft device disclosed in Patent Literature 1 is configured to, e.g., change the priority level of biometric information based on the authentication result of the identification information, and when an owner of a mobile device and a user using the mobile device are different, authentication fails since the priority level of the biometric information of the owner is higher, hence, inconvenient.

It is an object of the invention to provide an authentication control device and an authentication control system which are capable of suppressing a decrease in convenience.

### Solution to Problem

According to an embodiment of the invention, an authentication control device comprises a control unit that notifies to change related information when, after a first authentication by a first authentication device is successful and the priority level of the related information associated with the authenticated user is subsequently raised, the number of unsuccessful attempts of a second authentication performed by a second authentication device based on the related information reaches or exceeds a predetermined number.

According to another embodiment of the invention, an authentication control system comprises a first authentication device that performs a first authentication based on communication with a handheld device carried by a user outside a vehicle, a second authentication device that performs a second authentication inside the vehicle using user's biometric information, and an authentication control device comprising a control unit that notifies to change related information when, after the first authentication by the first authentication device is successful and the priority level of the related information associated with the authenticated user is subsequently raised, the number of unsuccessful attempts of the second authentication using biometric information and performed by the second authentication device based on the related information reaches or exceeds a predetermined number.

### Advantageous Effects of Invention

According to an embodiment of the invention, it is possible to provide an authentication control device and an authentication control system which are capable of suppressing a decrease in convenience.

### BRIEF DESCRIPTION OF DRAWINGS

FIG. 1A is a block diagram illustrating an authentication control device and an authentication control system in an embodiment.

FIG. 1B is an explanatory diagram illustrating the interior of a vehicle mounting the authentication control device and the authentication control system in the embodiment.

FIG. 2A is an explanatory diagram illustrating related information held in the authentication control device in the embodiment.

FIG. 2B is an explanatory diagram illustrating a display image when issuing a notification by display on a display device in the authentication control system in the embodiment.

FIG. 3 is a flowchart showing an operation of the authentication control device in the embodiment.

### DESCRIPTION OF EMBODIMENTS

### Summary of the Embodiment

An authentication control device in an embodiment of the invention has a control unit that notifies to change related information when, after a first authentication by a first authentication device is successful and the priority level of the related information associated with the authenticated user is subsequently raised, the number of unsuccessful attempts of a second authentication performed by a second authentication device based on the related information reaches or exceeds a predetermined number.

When the priority level of a user authenticated in the first authentication is raised and this causes the second authentication to be unsuccessful, the authentication control device encourages the user to change the related information. Therefore, unlike when such a configuration is not adopted, it is possible to change the related information so that the second authentication can be successful easily, and it is thereby possible to suppress a decrease in convenience.

### Embodiment

### (General Configuration of Authentication Control Device 1)

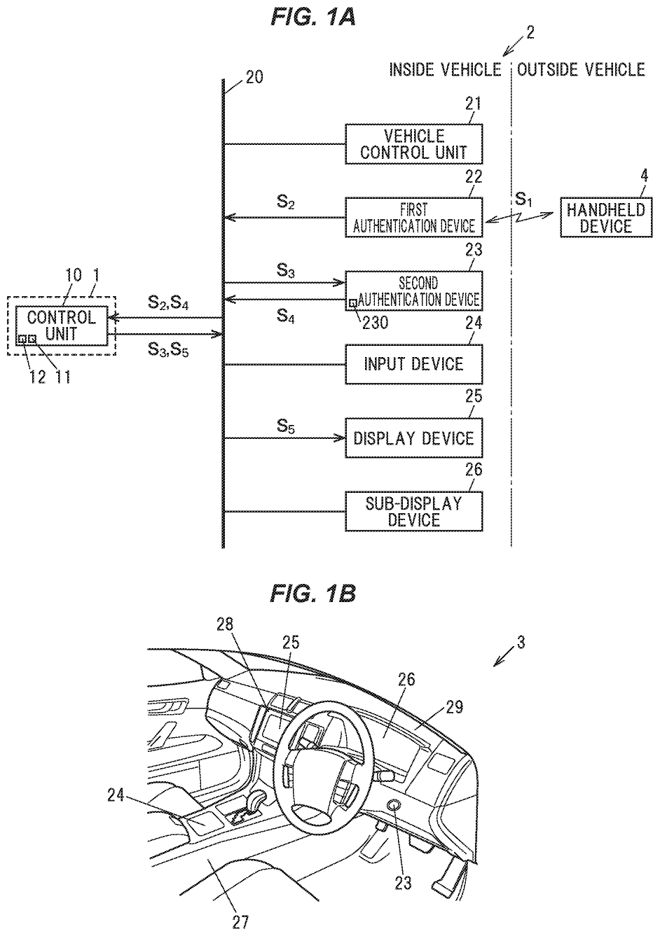

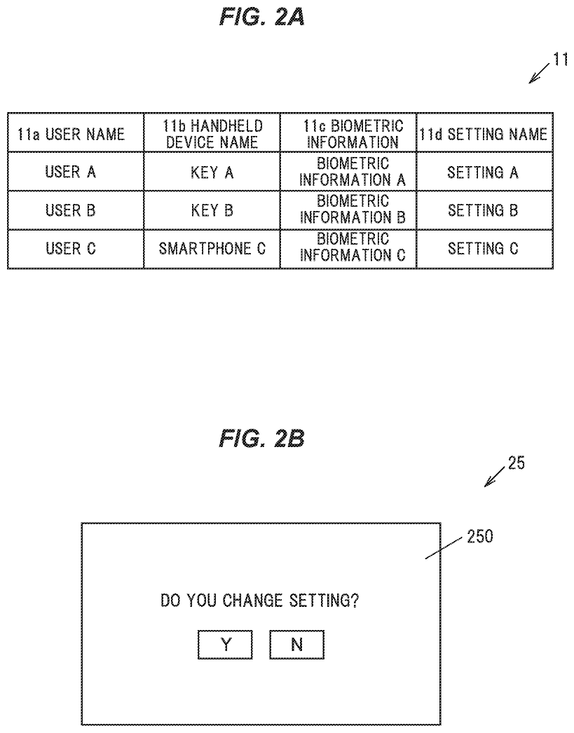

FIG. 1A is a block diagram illustrating an authentication control device and an authentication control system in an embodiment, and FIG. 1B is an explanatory diagram illustrating the interior of a vehicle mounting the authentication control device and the authentication control system in the embodiment. FIG. 2A is an explanatory diagram illustrating related information held in the authentication control device in the embodiment and FIG. 2B is an explanatory diagram illustrating a display image when issuing a notification by display on a display device in the authentication control system in the embodiment. In each drawing of the embodiment described below, a scale ratio may be different from an actual ratio. In addition, in FIG. 1A, flows of main signal and information are indicated by arrows.

As shown in FIG. 1A, the authentication control device 1 has, e.g., a control unit 10 which notifies to change related information 11 when, after a first authentication by a first authentication device 22 is successful and the priority level of the related information 11 associated with the authenticated user is subsequently raised, the number of unsuccessful attempts of a second authentication performed by a second authentication device 23 based on the related information 11 reaches or exceeds a predetermined number (N times).

The control unit 10 is configured to count the number of unsuccessful attempts of the second authentication after the first authentication device 22 performs the first authentication based on communication with a handheld device 4 carried by a user outside a vehicle 3 and when the second authentication device 23 performs the second authentication using biometric information associated with a user who is registered on the handheld device 4 and has a priority level which has been raised.

The control unit 10 notifies to change the related information 11 also when a user authenticated in the first authentication is different from a user authenticated in the second authentication.

The authentication control device 1 is included in, e.g., an authentication control system 2, as shown in FIG. 1A.

In detail, as shown in FIGS. 1A and 1B, the authentication control system 2 has, e.g., the first authentication device 22 which performs the first authentication based on communication with the handheld device 4 carried by a user outside the vehicle 3, the second authentication device 23 which performs the second authentication inside the vehicle 3 using user's biometric information, and the authentication control device 1 having the control unit 10 that notifies to change the related information 11 when, after the first authentication by the first authentication device 22 is successful and the priority level of the related information 11 associated with the authenticated user is subsequently raised, the number of unsuccessful attempts of the second authentication using biometric information and performed by the second authentication device 23 based on the related information 11 reaches or exceeds a predetermined number (N times).

The authentication control system 2 is further provided with, e.g., an in-vehicle LAN (Local Area Network) 20, a vehicle control unit 21, an input device 24, a display device 25 and a sub-display device 26, as shown in FIG. 1A,

### (Configuration of the Control Unit 10)

The control unit 10 is, e.g., a microcomputer composed of a CPU (Central Processing Unit) performing calculation and processing, etc., of the acquired data according to a stored program, and a RAM (Random Access Memory) and a ROM (Read Only Memory) which are semiconductor memories, etc. The ROM stores, e.g., a program for operation of the control unit 10, the related information 11, and count information 12. The RAM is used as, e.g., a storage area for temporarily storing calculation results, etc.

The related information 11 is information of, e.g., user name Ha, handheld device name 11b, biometric information lie and setting name 11d which are associated with each other. The related information 11 shown in FIG. 2A includes Users A to C as the user name 11a, Keys A, B and Smartphone C as the handheld device name 11b, Biometric Information A to C as the biometric information lie, and Settings A and B as the setting name 11d, as an example. Key A and Key B are identifiers for, e.g., electronic keys. Meanwhile, Smartphone C is an identifier for, e.g., a multifunctional mobile phone capable of communicating with the first authentication device 22.

The biometric information 11c is an identifier for, e.g., a template stored in the second authentication device 23. The setting name 11d is an identifier for, e.g., retrieving the setting made by the user, such as a position of a seat or an angle of a mirror.

Based on, e.g., user information S₂ output from the first authentication device 22, the control unit 10 determines the user registered on the handheld device 4 and outputs priority information S₃ to the second authentication device 23 to raise the priority level of the biometric information 11c of this user. When, e.g., the priority information S₃ to raise the priority level of User C is input, the second authentication device 23 performs authentication using the template of User C included in template information 230.

Meanwhile, when, based on the user information S₂, the control unit 10 determines that the user of the handheld device 4 is User B, the control unit 10 generates the priority information S₃ to give higher priority to Setting B of User B and sends it to a corresponding electronic device. This electronic device adjusts the position of the seat based on the input priority information S₃.

Now, when User C gets inside the vehicle 3 while carrying the handheld device 4 belonging to User B, the control unit 10 outputs the priority information S₃ to give higher priority to User B, based on the user information S₂. However, User C is actually using the handheld device 4. Therefore, the first attempt of the second authentication is unsuccessful. Based on authentication information S₄ output from the second authentication device 23, the control unit 10 determines that the second authentication is unsuccessful due to giving high priority to User B, and updates the count information 12.

The count information 12 is information about the number of unsuccessful attempts of the second authentication performed after the successful first authentication.

When, e.g., the number of unsuccessful attempts to authenticate User B reaches or exceeds a predetermined number (N times), the control unit 10 determines that a user other than User B is using the handheld device 4 of User B, and issues a notification to encourage to change the related information 11. The predetermined number is ten times (N=10), as an example.

Changing the related information 11 includes, e.g., changing the handheld device name 11b of User C from Smartphone C to Key B of User B, and creating new related information 11 in case of a new user, etc.

When, e.g., notifying to change the related information 11, the control unit 10 generates and outputs a notification signal S₅ via the in-vehicle LAN 20 to the display device 25, etc., which produces a notification.

(Configuration of the in-Vehicle LAN 20)

The in-vehicle LAN 20 enables intercommunication using a standard such as CAN (Controller Area Network) and LIN (Local Interconnect Network). The authentication control system 2 is configured so that, e.g., the authentication control device 1, the first authentication device 22 and the second authentication device, etc., can communicate via the in-vehicle LAN 20.

### (Configuration of the Vehicle Control Unit 21)

The vehicle control unit 21 is, e.g., a microcomputer composed of a CPU, a RAM and a ROM, etc. The vehicle control unit 21 is configured to perform overall control of, e.g., the in-vehicle LAN 20 and the first authentication device 22, etc.

### (Configuration of the First Authentication Device 22)

The first authentication device 22 is configured to verify, e.g., whether or not the handheld device 4 is registered to the vehicle 3. For example, the first authentication device 22 acquires identification information S₁ from the handheld device 4 and verifies whether the handheld device 4 is registered. The identification information S₁ is information unique to the handheld device 4.

When, e.g., the authentication is successful, the first authentication device 22 generates and outputs the user information S₂ via the in-vehicle LAN 20 to the vehicle control unit 21, the authentication control device 1, etc. When, e.g., the user information S₂ is input, the vehicle control unit 21 changes the state of the doors of the vehicle 3 from the locked state to the unlocked state, and allows the second authentication device 23 to perform authentication.

### (Configuration of the Second Authentication Device 23)

The second authentication device 23 is, e.g., to scan user's biometric information. As an example, the second authentication device 23 is configured as a start switch for giving an instruction to turn on/off a drive system of the vehicle 3, as shown in FIG. 1B. As an example, the second authentication device 23 may be configured to use biometric information such as facial image or iris to perform authentication for an electronic device other than the start switch.

The second authentication device 23 compares, e.g., a scanned fingerprint or vein of an operating finger performing an operation on the start switch against the biometric information template used for authentication of fingerprint or vein, and determines whether the operator is a registered person. The second authentication device 23 has the template information 230 as, e.g., information of template of each user.

The second authentication device 23 changes the authentication priority based on the priority information S₃ output from the authentication control device 1. The second authentication device 23 also generates and outputs the authentication information S₄ indicating that the authentication is successful or unsuccessful.

Fingerprint is scanned using, e.g., a sensor configured to scan the fingerprint pattern, such as optical, capacitive, electrical field intensity measurement, pressure-sensitive, or thermal, etc.

Vein of an operating finger or palm is scanned using, e.g., a sensor configured to scan the vein pattern based on reflection of emitted infrared light.

Facial image is scanned using, e.g., a sensor configured to scan an uneven shape on a subject based on depths at plural measurement points on the captured subject.

Iris is scanned using, e.g., a sensor configured to scan an iris by emitting infrared light and processing the captured image.

### (Configuration of the Input Device 24)

As an example, the input device 24 is a touchpad arranged on a floor console 27 between the driver's seat and the front passenger seat of the vehicle 3, as shown in FIG. 1B. This touchpad is, e.g., a capacitive touch sensor and is configured to detect a dragging operation, a push operation or a touch operation, etc. Then, the input device 24 allows to, e.g., operate a cursor displayed on the display device 25, scroll the menu or map, or input characters.

### (Configuration of the Display Device 25)

As an example, the display device 25 is arranged on a center console 28 located diagonally in front of the driver's seat and the front passenger seat, as shown in FIG. 1B. The display device 25 is, e.g., a liquid crystal monitor.

The display device 25 displays, e.g., a display image 250 to notify to change the related information 11 as shown in FIG. 2B, based on the notification signal S₅ output from the control unit 10 of the authentication control device 1. The display image 250 has, e.g., a text such as “Do you change the setting?”. The user can change the related information 11 by using the input device 24 and selecting the displayed “Y”.

As a modification, the control unit 10 may be configured to issue a notification by using at least one of sound, light and display. The control unit 10 issues a notification by, e.g., sound using a speaker mounted on the vehicle 3. The control unit 10 issues a notification by, e.g., light using the display device 25 or the sub-display device 26. The control unit 10 may combine notifications by, e.g., sound, light and display.

### (Configuration of the Sub-Display Device 26)

The sub-display device 26 is arranged on, e.g., an instrument panel 29, as shown in FIG. 1B. The sub-display device 26 is, e.g., a liquid crystal monitor. For example, meters and gauges are displayed on the sub-display device 26.

As a modification, the sub-display device 26 may be configured to, e.g., display a notification based on the notification signal S₅, in the same manner as the display device 25. The display of the notification may appear on only the display device 25, only the sub-display device 26, or both.

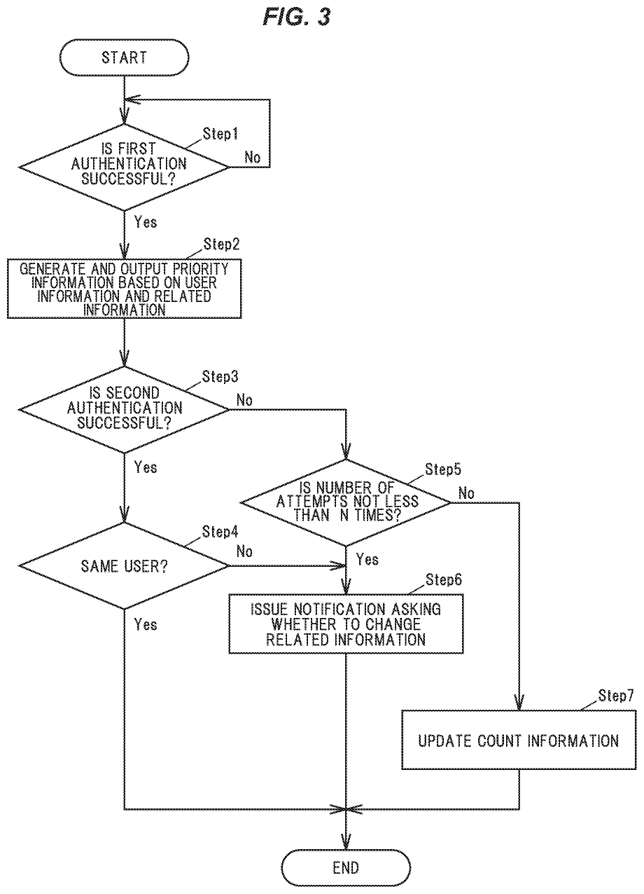

An example of an operation of the authentication control device 1 in the present embodiment for issuing a notification will be described below along with the flowchart in FIG. 3.

### (Operation)

When the authentication of the handheld device 4 by the first authentication device 22 is successful, i.e., when it is “Yes” in Step 1 (Step 1: Yes) and the user information S₂ for identifying the user is input, the control unit 10 of the authentication control system 2 generates the priority information S₃ based on the user information S₂ and the related information 11 and outputs it to the second authentication device 23 via the in-vehicle LAN 20 (Step 2).

The second authentication device 23 performs the second authentication after raising the priority level of the user based on the priority information S₃, and outputs the authentication information S₄, which is based on the authentication result, to the authentication control device 1 via the in-vehicle LAN 20.

Based on the authentication information S₄, the control unit 10 checks whether or not the second authentication is successful. When the second authentication is successful (Step 3: Yes), the control unit 10 checks whether the user authenticated in the first authentication is the same as the user authenticated in the second authentication.

When the user authenticated in the first authentication is the same as the user authenticated in the second authentication (Step 4: Yes), it is not necessary to issue a notification and the control unit 10 thus ends the process.

Meanwhile, when the second authentication is unsuccessful in Step 3 (Step 3: No), the control unit 10 checks, based on the count information 12, the number of unsuccessful attempts of the second authentication performed to authenticate the user who was given high priority based on the user information S₂.

When the number of unsuccessful attempts is not less than N times (Step 5: Yes), the control unit 10 generates the notification signal S₅ for encouraging to change the related information 11 and outputs it to the display device 25, etc., via the in-vehicle LAN 20 (Step 6). When the related information 11 is changed, the control unit 10 resets the count information 12 of the corresponding user.

Meanwhile, when the user authenticated in the first authentication is different from, i.e., is not the same as the user authenticated in the second authentication in Step 4 (Step 4: No), the control unit 10 proceeds the process to Step 6 and encourages to change the related information 11.

Then, when the number of unsuccessful attempts is less than N times in Step 5 (Step 5: No), the control unit 10 updates the count information 12 and then ends the process (Step 7).

### (Effects of the Embodiment)

The authentication control device 1 in the present embodiment can suppress a decrease in convenience. In detail, the authentication control device 1 can notify to change the related information 11 after the successful first authentication, depending on the number of unsuccessful attempts of the second authentication performed to authenticate the user who is given high priority. Therefore, unlike when such a configuration is not adopted, it is possible to prevent the second authentication from being unsuccessful in every use and thereby to suppress a decrease in convenience.

The second authentication is biometric authentication and it thus takes time to successfully authenticate, depending on the order of authentications. When an owner of a handheld device is different from a user using the handheld device and the user uses the handheld device more often than the owner, the authentication control device 1 can perform biometric authentication using the template of the user after reaching the predetermined number of attempts, hence, time for authentication is reduced.

In case that the setting is changed as a result of issuing a notification, the authentication control device 1 can give appropriate priority even when an owner of a handheld device is different from a user using the handheld device and the user uses the handheld device more often than the owner. Since the first authentication is performed outside the vehicle 3 and the second authentication is performed inside the vehicle 3, the second authentication can be performed smoothly when the priority is appropriate, hence, the authentication control device 1 is highly convenient.

The authentication control device 1 encourages to change the related information 11 also when the user authenticated in the first authentication is different from the user authenticated in the second authentication. Therefore, the related information 11 can be more appropriate than when such a configuration is not adopted.

Although some embodiment and modifications of the invention have been described, the embodiment and modifications are merely examples and the invention according to claims is not to be limited thereto. These new embodiment and modifications may be implemented in various other forms, and various omissions, substitutions and changes, etc., can be made without departing from the gist of the invention. In addition, all combinations of the features described in the embodiment and modifications are not necessary to solve the problem of the invention. Further, these embodiment and modifications are included within the scope and gist of the invention and also within the invention described in the claims and the range of equivalency.

### REFERENCE SIGNS LIST

1 AUTHENTICATION CONTROL DEVICE
2 AUTHENTICATION CONTROL SYSTEM
3 VEHICLE
4 HANDHELD DEVICE
10 CONTROL UNIT
11 RELATED INFORMATION
11a USER NAME
11b HANDHELD DEVICE NAME
11c BIOMETRIC INFORMATION
11d SETTING NAME
12 COUNT INFORMATION
22 FIRST AUTHENTICATION DEVICE
23 SECOND AUTHENTICATION DEVICE
230 TEMPLATE INFORMATION

1. An authentication control device, comprising a control unit that notifies to change related information when, after a first authentication by a first authentication device is successful and the priority level of the related information associated with the authenticated user is subsequently raised, the number of unsuccessful attempts of a second authentication performed by a second authentication device based on the related information reaches or exceeds a predetermined number.

2. The authentication control device according to claim 1, wherein, after the first authentication device performs the first authentication based on communication with a handheld device carried by a user outside a vehicle and when the second authentication device performs the second authentication using biometric information associated with a user who is registered on the handheld device and has a priority level which has been raised, the control unit counts the number of unsuccessful attempts of the second authentication.

3. The authentication control device according to claim 1, wherein the control unit notifies to change the related information also when a user authenticated in the first authentication is different from a user authenticated in the second authentication.

4. The authentication control device according to claim 1, wherein the control unit resets the count of the number of unsuccessful attempts of the second authentication when the related information is changed.

5. The authentication control device according to claim 1, wherein the control unit uses one or more selected from sound, light and display when notifying to change the related information.

6. An authentication control system, comprising:
a first authentication device that performs a first authentication based on communication with a handheld device carried by a user outside a vehicle;
a second authentication device that performs a second authentication inside the vehicle using user's biometric information; and
an authentication control device comprising a control unit that notifies to change related information when, after the first authentication by the first authentication device is successful and the priority level of the related information associated with the authenticated user is subsequently raised, the number of unsuccessful attempts of the second authentication using biometric information and performed by the second authentication device based on the related information reaches or exceeds a predetermined number.

7. The authentication control system according to claim 6, wherein the first authentication device verifies, as the first authentication, whether or not the handheld device is registered to the vehicle based on unique identification information output from the handheld device, and outputs user information when the authentication is successful.

8. The authentication control system according to claim 6, wherein the first authentication device receives an input of the identification information from an electronic key or a multifunctional mobile phone as the handheld device.

9. The authentication control system according to claim 6, wherein the second authentication device comprises a biometric information scanning means for scanning biometric information of an operator, a storage means storing biometric information of each user as template information, and a determination means that compares the biometric information of the operator scanned by the scanning means against biometric information of the user included in the template information in the storage means and corresponding to related information of the authenticated user having the priority level raised by the authentication control device, and determines whether or not the operator is the user.

10. The authentication control system according to claim 9, wherein the biometric information scanning means scans one or more selected from fingerprint, vein, facial image and iris as the biometric information of the operator, and the storage means stores one or more selected from fingerprint, vein, facial image and iris as the biometric information of each user.
